(19) United States
(12) Patent Application Publication
(10) Pub. No.: US 2021/0123787 A1
(43) Pub. Date: Apr. 29, 2021

(54) Radar measurement device and arrangement of a radar measurement device on a container

(71) Applicant: VEGA GRIESHABER KG, Wolfach (DE)

(72) Inventors: Roland Welle, Hausach (DE); Levin Dieterle, Oberwolfach (DE)

(21) Appl. No.: 17/078,183

(22) Filed: Oct. 23, 2020

(30) Foreign Application Priority Data
Oct. 23, 2019 (DE) 10 2019 128 582.8

(51) Int. Cl. G01F 23/284

(52) U.S. Cl. CPC G01F 23/284

(57) ABSTRACT

A radar measurement device with at least one transmitter to emit electromagnetic waves, the at least one transmitter being arranged inside a housing. The radar measurement device is intended to be securely and lastingly attachable to a flexible wall. For this purpose, at least a portion of the housing has an elastically deformable design. Furthermore, the arrangement of a radar measurement device to a fillable container is described.

### CROSS REFERENCE TO RELATED APPLICATIONS

This patent application claims priority to German Patent Application 102019128582.8, filed on Oct. 23, 2019.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a radar measurement device, specifically for fill level measurement, and the arrangement of such device on a container.

### Background of the Invention

Various embodiments of fill level measuring arrangements to determine and/or monitor the fill level inside a container are known. Radar fill level measurement apparatuses, for example fill level measurement devices which operate according to the transit time principle, emit pulses of electromagnetic radiation at a certain wavelength and then detect the temporal progression of the reflected electromagnetic radiation as an echo curve. Among other things, these devices detect reflections on the surface of the liquid to be measured and/or of the contents of the container. The sum of the reflections then yield a signal that can be measured as a function of time and depicted as an echo curve vs. time and which usually has several peaks. The course of this echo curve is then used to determine the fill level of the liquid inside the container.

To measure a fill level inside a container, radar measurement devices are usually mounted inside the container cover or in an orifice in the container created for that purpose. In the case of a plastic container made of material (e.g. HD-PE) that is transparent to the electromagnetic radiation in the relevant frequency range, a measurement through the container wall is also conceivable. The wall of the container is usually flexible in design and is deformed as a function of the fill level inside the container. The device can alternatively be mounted on an uneven surface. The device can be attached using adhesive, among other options. Specifically, in the case of radar measurement devices attached with adhesive, a radar measurement device attached to an uneven wall that is e.g. arched or corrugated may come loose due to the deformation of the wall. The results of the measurement would thus be corrupted, or the measurement would even fail entirely.

Based on these findings, the underlying objective of the present invention is to provide a radar measurement device and an arrangement of a radar measurement device on a container, enabling the secure and lasting attachment to an uneven substrate, or one that is subject to slight deformations over time.

The objective is achieved with a radar measurement device as described herein.

### BRIEF SUMMARY OF THE INVENTION

In a preferred embodiment, a radar measurement device (2) comprising at least one transmitter/receiver unit (8) for electromagnetic waves, the transmitter/receiver unit (8) being arranged inside a housing (4), characterized in that at least a portion (14) of the housing (4) is designed to be elastically deformable.

In a preferred embodiment, a radar measurement device as described herein, characterized in that the portion (14) is a housing wall (16) oriented towards the main emission direction (E) of the transmitter/receiver module (8).

In a preferred embodiment, a radar measurement device as described herein, characterized in that the elastically deformable housing wall (16) has a lens (22, 24, 26).

In a preferred embodiment, a radar measurement device as described herein, characterized in that the lens (22, 24, 26) is itself elastically deformable in design.

In a preferred embodiment, a radar measurement device as described herein, characterized in that the lens is rigid in design and is connected with the housing wall (16) by elastically deformable means.

In a preferred embodiment, a radar measurement device as described herein, characterized in that the lens is a Fresnel lens (22) or a diffractive optical element (24).

In a preferred embodiment, a radar measurement device as described herein, characterized in that the elastically deformable portion (14) has at least one groove (30).

In a preferred embodiment, a radar measurement device as described herein, characterized in that the elastically deformable portion (14) of the housing (4) is convex in its unstressed state.

In a preferred embodiment, a radar measurement device as described herein, characterized in that the inward side of the elastically deformable portion (14) has a flexible, dielectric, adaptive layer.

In a preferred embodiment, a radar measurement device as described herein, characterized in that the elastic portion (14) of the housing (4) can be deflected towards the inside of the housing only to such an extent that this portion (14) does not come into contact with the transmitter/receiver unit (8, 28).

In a preferred embodiment, a radar measurement device as described herein, arranged on a fillable container having an uneven wall (18), to which the radar measurement device (2) is attached.

### BRIEF DESCRIPTION OF THE DRAWINGS

FIG. 1 is a schematic sectional drawing of a radar measurement device according to the invention, with an elastically deformable housing wall in a first embodiment;

FIG. 2 is a schematic sectional drawing of the housing wall in a second embodiment;

FIG. 3 is a schematic sectional drawing of the housing wall in a third embodiment;

FIG. 4 is a schematic sectional drawing of the housing wall in a fourth embodiment;

FIG. 5 is a schematic sectional drawing of the housing wall in a fifth embodiment;

FIG. 6 is a schematic sectional drawing of a radar measurement device according to the invention with an elastically deformable housing wall in a sixth embodiment; and

FIG. 7 is a schematic sectional drawing of a radar measurement device according to the invention with an elastically deformable housing wall in a seventh embodiment.

### DETAILED DESCRIPTION OF THE INVENTION

The invention is a radar measurement device and/or a radar fill level measurement device according to the invention comprises at least one transmitter to emit electromagnetic waves of at least one wavelength. The waves are emitted by the transmitter mainly in the main emission direction E. The transmitter may be a radar chip with at least one integrated primary exciter. A separate patch or horn antenna may alternatively also be provided. The radar fill level measurement device according to the invention further comprises at least one receiver for the reflected electromagnetic waves. The transmitter and the receiver may also be designed as a combined transmitter/receiver unit.

The at least one transmitter is arranged inside a housing, the housing being at least partly elastic in design (in the main emission and/or main reception direction). Specifically, the housing completely surrounds the at least one transmitter/receiver and any electronic components and comprises one or more circumferential side walls. The housing specifically forms a mechanical protection for the transmitter/receiver and is preferably designed to be tight in such a way that no humidity or liquid can penetrate the housing. In the present invention, the term “elastically deformable” shall be used to characterize a portion of the housing which, upon deformation, can be returned to its original shape.

The elastically deformable portion may be a side wall and/or a wall of the housing. The housing may be specifically produced using two-component injection molding, with a rigid part of the housing being made of a first component, and an elastic portion of a second component.

Alternatively or additionally, an elastically deformable compensating element disposed on the outer side of a sidewall is considered an elastically deformable portion of the housing. Such an elastically deformable compensating element may be e.g. a flexible material, such as foam rubber or a rubbery material inserted between a rigid side wall and a container.

An elastically deformable portion of the housing would allow the housing of the radar measurement device designed according to the invention to largely adjust to the uneven surface in this portion of the housing, such as a arching or corrugated wall, and thus allow it to be attached to that wall especially firmly. This would prevent the radar measurement device from coming loose from the wall either partly or entirely due to an excessive flexural strength of the housing. The formation of an at least partly elastically deformable housing is advantageous especially for radar measurement devices whose housings are attached to a flexible wall using adhesive. It would specifically prevent the housing from becoming partly detached from the bonding surface, and water would be kept from penetrating the space between the housing and the wall, a potential cause of false measurements.

A radar measurement device used to measure the fill level inside a container is usually attached to a wall of the container in such a way that the measurement is made from above onto the surface of the contents. The radar measurement device is specifically arranged outside the container wall, above the contents. The container wall is deformed and/or arched depending on the fill level or pressure inside the container and the temperature. The radar measurement device preferably has a portion in the form of a housing wall oriented in the main emission direction relative to the transmitter and elastically deformable in design. The radar measurement device is specifically arranged above the container in such a way that the housing rests against the outside of the container with this housing wall.

The elastically deformable housing wall, and also an elastically deformable compensating element, are specifically made of a material that is transparent to the electromagnetic waves emitted and received, e.g. plastic such as polyethylene, polypropylene or a similar material.

Preferably, the other components of the housing, e.g. additional side walls and a rear wall as well as any fixtures to attach the transmitter, have a higher flexural strength, forming the connection between the elastically deformable housing wall and the transmitter. The rest of the housing is thus stable to any forces acting on it, and the position of the transmitter inside the housing can be maintained as well as possible.

To focus and concentrate the electromagnetic radiation emitted and/or received, the elastically deformable housing wall oriented towards the main emission direction may have a lens. The lens may itself be elastically deformable in design. Specifically, the lens may be made of a gel-like, dielectric material which follows any deformation of the housing wall.

The lens may alternatively be rigid in design and connected with the flexible housing wall by elastically deformable means. Such elastically deformable means may be e.g. foldable and/or concertina-type structures, which become longer or shorter if the housing wall is deformed.

Preferably, the lens on the elastically deformable housing wall is formed in one piece and/or is integrated into the wall. In other words, the elastically deformable housing wall forms a lens.

In a practical embodiment of the radar measurement device according to the invention, the lens is a Fresnel lens. Such a design would comprise concentric circular structures in the flexible housing wall, which would concentrate the electromagnetic waves. Fresnel lenses have the advantage compared to conventional lenses with the same focal length of being thinner and lighter, so that they can be designed to be especially flexible here. The housing wall may have a surface structure that is equivalent to a Fresnel lens. Specifically, the Fresnel lens is provided inside the housing wall. To achieve an emission characteristic of the emitted waves that is as uniform as possible, the Fresnel lens may be a plano-convex lens, with the flat side facing the housing wall.

A diffractive optical element (DOE) may alternatively be provided as a lens. In such a design, different microstructures are applied specifically to the housing wall, which can focus the emitted electromagnetic waves due to the different optical path lengths of their partial beams. Also in this case, microstructures may be applied to the housing wall itself, specifically to the inside of the housing wall.

Specifically, the elastically deformable portion has at least one groove. The housing material in the area of the groove is thinner, and the housing is therefore more extensible and compressible. Specifically, the elastically deformable portion has several grooves spaced at a certain distance.

In another practical embodiment, the elastically deformable portion of the housing, specifically the housing wall, is convex in its unstressed state. This means that this portion is deflected at the center relative to the outer ends. Specifically, that portion is arched outwards. Specifically, the maximum deflection is between 0.1 mm and 5 mm, preferably 0.1 mm to 3 mm. “Unstressed state” shall mean the state before the radar measurement device is attached to a wall, or a state where no forces act upon that portion. The convex shape of the elastically deformable portion facilitates its attachment to a flexible wall. Specifically, if the unit is attached using adhesive, maximum contact between the deformable portion and the bonding surface is made possible, and the inclusion of air bubbles is avoided.

Furthermore, the side of the elastically deformable portion facing inside the housing wall preferably oriented in the main emission direction E may have a flexible, dielectric adaptive layer. The dielectric adaptive layer is provided to avoid reflections at the housing wall.

In another practical embodiment of a radar measurement device according to the invention the elastically deformable portion of the housing, and specifically the elastically deformable wall in the direction of the inside of the housing, can only be deflected to such an extent that it does not come into contact with the at least one transmitter. This is to prevent the transmitter from coming into contact with the housing wall and thus being damaged if the housing wall is deformed. If such a contact is to be allowed for, the elastically deformable portion in areas with possible points of contact can be designed to be especially flexible or made of especially soft material.

The invention also concerns an arrangement of a radar measurement device as described above on a container that can be filled. The fillable container specifically has a deformable and/or flexible wall in the direction of the radar measurement device that is sometimes not planar and to which the housing of the radar measurement device with the elastically deformable housing wall is attached.

Regarding the benefits of the arrangement, reference is made here to the above description.

Specifically, the housing wall and the wall are arranged so as to be indirectly adjacent to each other, with a layer of adhesive between them. The adhesive is preferably a double-sided, closed-cell acrylate adhesive tape. The adhesive layer may cover the entire surface between the housing and the wall. Alternatively, a merely partial application of adhesive is also conceivable, e.g. a possible ring-shaped application of adhesive.

The interaction of the partly elastically deformable housing with the likewise deformable adhesive provides an especially secure attachment of the radar measurement device to the container, which above all is impervious to the ingress of water.

### DETAILED DESCRIPTION OF THE FIGURES

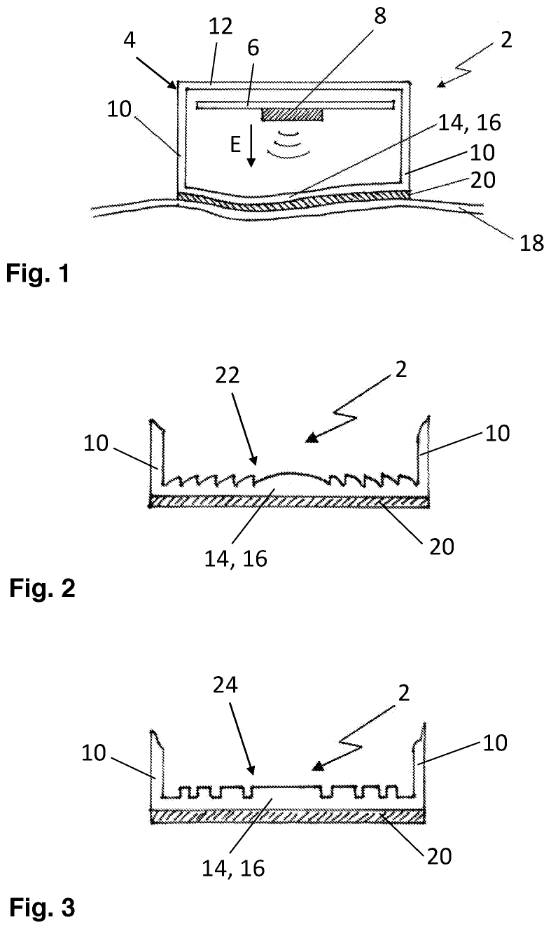

FIG. 1 shows a first embodiment of a radar measurement device 2. In this case, the radar measurement device 2 is a radar fill level measurement device to be arranged on a wall 18 of a container in order to measure the fill level of the contents inside the container (not shown).

The radar measurement device 2 is surrounded by a housing 4, the inside of the housing containing a printed circuit board 6 with a transmitter/receiver unit 8 to generate, emit and receive electromagnetic waves. In this embodiment, the transmitter/receiver unit 8 is a radar chip with an integrated primary exciter inside the housing 4. The main emission direction E, extending downwards from the transmitter/receiver unit 8, is shown in FIG. 1. The housing 4 has two deflection resistant side walls 10 and one deflection resistant rear wall 12. The housing 4 further has a portion 14, in this case a housing wall 16 that is elastically deformable and oriented towards the main emission direction E.

As can be seen in FIG. 1, the housing 4 with the elastically deformable housing wall 16 is attached to the wall 18, in this case a flexible cover of the container. The housing is attached using adhesive. For this purpose, a layer of adhesive 20 is placed between the container wall 18 and the housing wall 16. In the present invention, the adhesive is acrylate adhesive tape. FIG. 1 already shows clearly that the container wall 18 is flexible and can be deformed, specifically corrugated and arched. The deformation of the layer of adhesive 20 and of the elastically deformable housing wall 16 follows the deformation of the container wall 18. The other components 10, 12 of the housing largely remain rigid.

Both the housing wall 16 and the layer of adhesive 20 and the container wall 18 are designed to be transparent to the emitted waves and in the present invention are elastically deformable. The fill level inside the container is measured by the electromagnetic waves that propagate from the transmitter/receiver unit 8 through the housing wall 16, the layer of adhesive 20 and the container wall 18, and then impinge on the contents of the container. The rays reflected from there are then detected by the receiver 8.

Other embodiments of the radar measurement device 2 are explained in connection with FIGS. 2 to 5 below, each of the figures showing only a portion of the housing 4, the elastically deformable housing wall 16 and the layer of adhesive 20.

The same reference marks are used for identical elements, or at least elements with the same function, to describe the further embodiments as for the description of the first embodiment.

FIG. 2 shows an elastically deformable housing wall 16, designed as a Fresnel lens 22. The inside of the housing wall 16 is structured in such a way that it acts as a Fresnel lens 22. The housing wall 16 has several concentric ring-shaped structures, depicted here in cross-section.

FIG. 3 shows another embodiment of a radar measurement device 2, the inside of the housing wall 16 being structured in such a way that it forms a diffractive optical element 24.

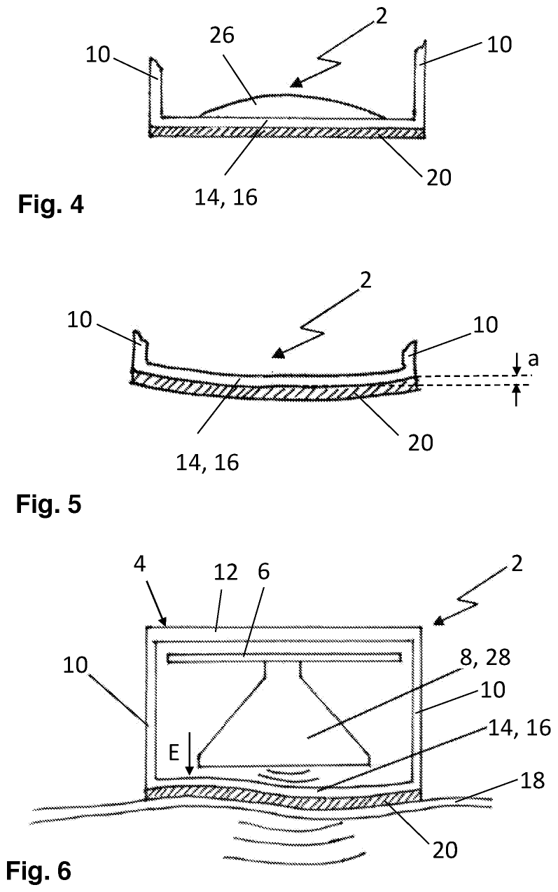

FIG. 4 shows another embodiment of a radar measurement device 2. In this embodiment, a separate lens 26 is arranged on the inside of the housing wall 16. This lens 26 consists of a gel-like dielectric material that is also elastically deformable and can follow the deformations of the housing wall 16.

Each of the lenses 22, 24, 26 shown in FIGS. 2 to 4 are designed in such a way that the waves emitted from the transmitter 8 in the main emission direction E emerge from the housing 4 if possible in uniform, parallel wave fronts, and conversely the waves reflected from the media to be measured are mainly focused on the receiver 8.

FIG. 5 shows another embodiment of a radar measurement device 2, in this case with a convex housing wall 16, i.e. with a design that is arched outwards. The maximum deflection a is 3 mm in this case. The radar measurement device 2 with the elastically deformable housing wall 16 is thus easier to attach to the container cover 18 using the adhesive.

FIG. 6 shows a sixth embodiment of a radar measurement device 2, the main difference from the first embodiment in connection with FIG. 1 being that the electromagnetic signal is sent and received using a horn antenna 28 provided inside the housing 4. It may also contain an additional lens. The elastically deflectable housing wall 16 is designed in such a way that it does not come into contact with the horn antenna 28 even in the event of maximum deflection towards the inside of the housing.

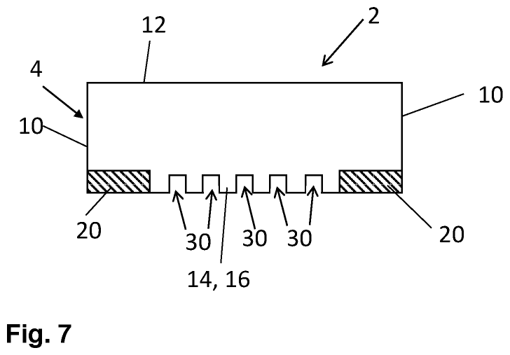

FIG. 7 shows a seventh embodiment of a radar measurement device 2. Here, the elastically deformable portion 14 is formed by a housing wall 16 with several grooves 30. Furthermore, in this case only a ring-shaped layer of adhesive 20 is applied to the housing 4 to attach the housing 4 to a container.

It should be noted that specifically the embodiments shown in FIGS. 1 and 6 can also be combined with housing walls 16 according to the embodiments shown in FIGS. 2 to 5 and FIG. 7. Another embodiment is also possible where the housing has rigid walls and is connected with a container via an elastically deformable portion 14 in the form of an elastically deformable compensating element.

### LIST OF REFERENCE NUMBERS

2 Radar measurement device
4 Housing
6 Fixture
8 Transmitter/receiver unit
10 Sidewall
12 Rear wall
14 Portion
16 Housing wall
18 Container wall, container cover
20 Adhesive layer
22 Fresnel lens
24 Diffractive optical element
26 Lens
28 Horn antenna
30 Groove
E Main emission direction
a Maximum deflection

Unless indicated otherwise, identical reference numbers in the figures identify identical components with the same function. The terms drive unit and drive are used interchangeably herein.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A radar measurement device comprising at least one transmitter/receiver unit for electromagnetic waves, the transmitter/receiver unit being arranged inside a housing, wherein at least a portion of the housing is designed to be elastically deformable.

2. The radar measurement device of claim 1, wherein the portion is a housing wall oriented towards the main emission direction of the transmitter/receiver module.

3. The radar measurement device of claim 1, wherein the elastically deformable housing wall has a lens.

4. The radar measurement device of claim 3, wherein the lens is itself elastically deformable in design.

5. The radar measurement device of claim 3, wherein the lens is rigid in design and is connected with the housing wall by elastically deformable means.

6. The radar measurement device of claim 3, wherein the lens is a Fresnel lens or a diffractive optical element.

7. The radar measurement device of claim 1, wherein the elastically deformable portion has at least one groove.

8. The radar measurement device of claim 1, wherein the elastically deformable portion of the housing is convex in its unstressed state.

9. The radar measurement device of claim 1, wherein the inward side of the elastically deformable portion has a flexible, dielectric, adaptive layer.

10. The radar measurement device of claim 1, wherein the elastic portion of the housing can be deflected towards the inside of the housing only to such an extent that this portion does not come into contact with the transmitter/receiver unit.

11. The radar measurement device of claim 1, wherein the radar measurement device is arranged on a fillable container having an uneven wall, to which the radar measurement device is attached.
